(19) United States
(12) Patent Application Publication
(10) Pub. No.: US 2019/0026511 A1
(43) Pub. Date: Jan. 24, 2019

(54) Tracking Method for Containers Having Removable Closures

(71) Applicant: Mississippi State University, Mississippi State, MS (US)

(72) Inventors: Wilburn Ray Whittington, Starkville, MS (US); Haitham El Kadiri, Mississippi State, MS (US); Rahhal Boulgoute, Rabat (MA); Marco Vendrame, Trieste (IT); Andrea Cossar, Trieste (IT); James Parker Stewart, Fayetteville, AR (US); Ankit Sanjay Kakadia, Birmingham, AL (US)

(73) Assignee: Mississippi State University, Mississippi State, MS (US)

(21) Appl. No.: 16/042,697

(22) Filed: Jul. 23, 2018

Related U.S. Application Data
(60) Provisional application No. 62/535,342, filed on Jul. 21, 2017.

(51) Int. Cl. G06K 7/10; B65D 51/24; B65D 39/00; B65B 61/26; G06K 7/14

(52) U.S. Cl. CPC G06K 7/10366; B65D 51/245; G06K 7/1417; B65B 61/26; G06K 7/1413; B65D 39/0011

(57) ABSTRACT

A method of tracking a container closure used to seal liquid in a container is provided, comprising applying a trackable indicia to a container closure, wherein the trackable indicia is unique to the container closure; recording an associated data set comprising a plurality of parameters related to the liquid in the container; correlating the associated data set with the trackable indicia; applying the container closure to the container to seal the liquid within the container; maintaining a database of the trackable indicia corresponding to the associated data set; and scanning the trackable indicia to retrieve the associated data set from the database.

### CROSS-REFERENCE TO RELATED APPLICATION

This application claims priority from U.S. Provisional Patent Application Ser. No. 62/535,342 filed Jul. 21, 2017. The entirety of the provisional application is incorporated herein by reference.

### FIELD OF THE INVENTION

The invention relates generally to devices and methods used to track containers having removable closures from filling to consumption, and more particularly to such devices and methods which allow recording, storage, and use of data related to unique indicia applied to corks used to seal beverages, such as wine and similar products.

### SUMMARY OF THE INVENTION

In a preferred embodiment, a method of tracking a container closure used to seal liquid in a container is provided, comprising applying a trackable indicia to a container closure, wherein the trackable indicia is unique to the container closure; recording an associated data set comprising a plurality of parameters related to the liquid in the container; correlating the associated data set with the trackable indicia; applying the container closure to the container to seal the liquid within the container; maintaining a database of the trackable indicia corresponding to the associated data set; and scanning the trackable indicia to retrieve the associated data set from the database.

In another embodiment, the method further comprises updating the associated data set by scanning the trackable indicia upon the occurrence of predetermined events, and recording information about the predetermined events to the associated data set, wherein the predetermined events may comprise one or more of the following: transfer of possession of the container, removal of the container closure from the container, and consumption of the liquid.

In another embodiment, the plurality of parameters may comprise one or more of the following: liquid production data, qualities of the liquid, conditions present during filling of the container, conditions during aging of the liquid, and geographic data during movement of the container over time.

In a more preferred embodiment, the trackable indicia comprises a scannable image on the container closure, where the scannable image is a graphic image, a bar code, a quick response (QR) code, or a unique series of alphanumeric characters.

Optionally, the trackable indicia comprises a radio frequency identification (RFID) tag attached to the container closure.

In an alternate embodiment, the trackable indicia comprises a scannable pattern unique to material used to construct the container closure.

In a more preferred embodiment, the container closure may comprise a natural cork, a synthetic cork, or a screw-type cap, and the liquid may comprise an alcoholic beverage, such as wine.

The method may also include the step of scanning using a mobile device wirelessly connected to a global information network, such as the Internet.

In another alternate embodiment, the container closure includes a sensing device within the container closure adapted to detect one or more parameters related to the liquid in the container, and further includes a memory adapted to store parameter data, wherein the parameters related to the liquid are one or more of the following liquid conditions: age, internal pressure, temperature, oxygen and carbon dioxide levels, and acid concentration.

In a further embodiment, the parameter data stored in the memory is transmitted wirelessly to a mobile device and added to the associated data set.

The above and other objects and features of the present invention will become apparent from the drawings, the description given herein, and the appended claims.

### BACKGROUND OF THE INVENTION

There is a critical need for establishing multilateral communication between producers, distributors, retailers and consumers of wine and its bottling and sealing components. Cork, bottle, and wine producers, distributors, and retailers as well as wine consumers should have direct communication with one another to share data regarding a myriad of information related to the wine authenticity, quality, age, evolution, value, price, location, as well as information about the consumer, such as age, ethnicity, location, user profile and social characteristics.

Cork producers, wine producers, bottling producers, and their associated distributors currently have their own databases, profiles, and other information related to their aspects of the final wine product sold at a retailer. Still, consumers of wine have their own social profile information databases that are particular to them. Finally, retailers of wine have their own databases of their inventory, sales, and local consumers. However, the retailer is currently the primary entity which enjoys direct communication with the consumer at the time of sale, with the exception being consumers purchasing wine directly from a winery via a tasting room. The other entities related to the wine value chain would also like to have direct communication with the consumer at the time of sale.

During the lifecycle of a wine bottle, including bottling, packaging, shipping, storage, and purchase, all of the entities related to a bottle's lifecycle would be interested in continued updating of information from each other entity so that they can make the most informed decisions on the aspect of the value chain related to their expertise. For instance, a retailer would like to inform a wine distributor of their peak sales days, hours, and consumer profiles. Also, a wine distributor would like to inform a wine producer of changes in the wine characteristics (aging or maturation), real-time geographical sales information, and other critical data. Likewise, consumers would like to know more about the wines and other beverages they purchase and consume. There is also a desire to ensure authenticity of beverages, such as wines, champagnes, and other liquids, such that a consumer can be certain that the wine in the bottle is the actual wine of the producer on the label. In addition to those concerns, there is a need to trace the wine bottle's path through the market during its life cycle.

While the following description may refer to wine in many instances, the present invention applies to any liquid contained in a container, consumable or otherwise, where it is important to track details about the liquid in the container. Similarly, although the following description may refer to corks as one type of container closure, particularly those used to seal wine bottles, the present invention more broadly relates to any form of removable closure that is used to seal the container. With specific reference to wines, one way of establishing this system is to provide a means of tracking a cork used in the bottle which contains the wine. Because the cork always accompanies the wine contained in the bottle, from the bottling until the cork is removed, it is a convenient platform on which to base such a tracking method as described below.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 illustrates a schematic view of a preferred embodiment of the present invention in the form of a method of tracking a container closure.

FIG. 2 is a view of a container closure applied to seal a container and having a tracking indicia applied to the closure.

FIG. 3 is a view of a flowchart depicting various events during the life cycle of the container.

FIG. 4 is a schematic view of data flow in a preferred embodiment of the invention.

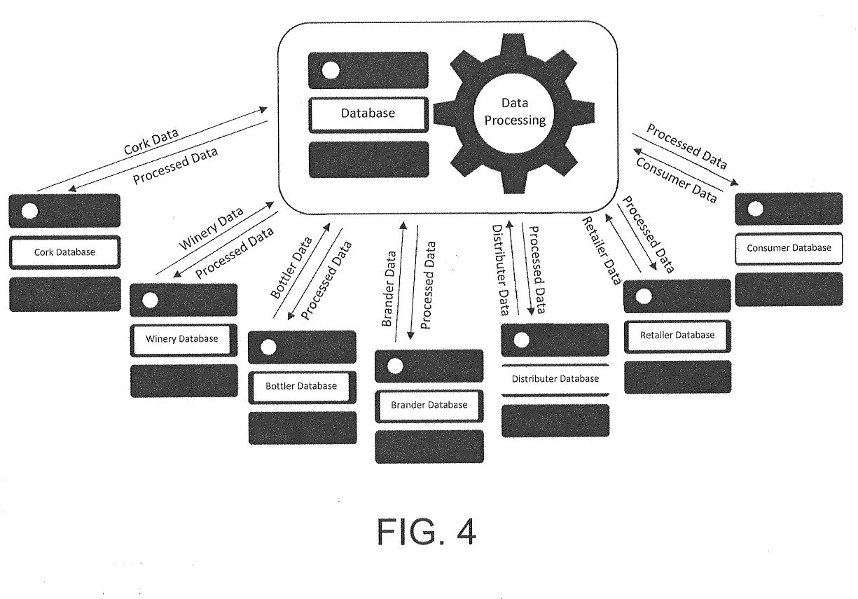

FIG. 5 is an alternative schematic view of interactions between an application programming interface (API) and various computing devices for exchanging data related to the container.

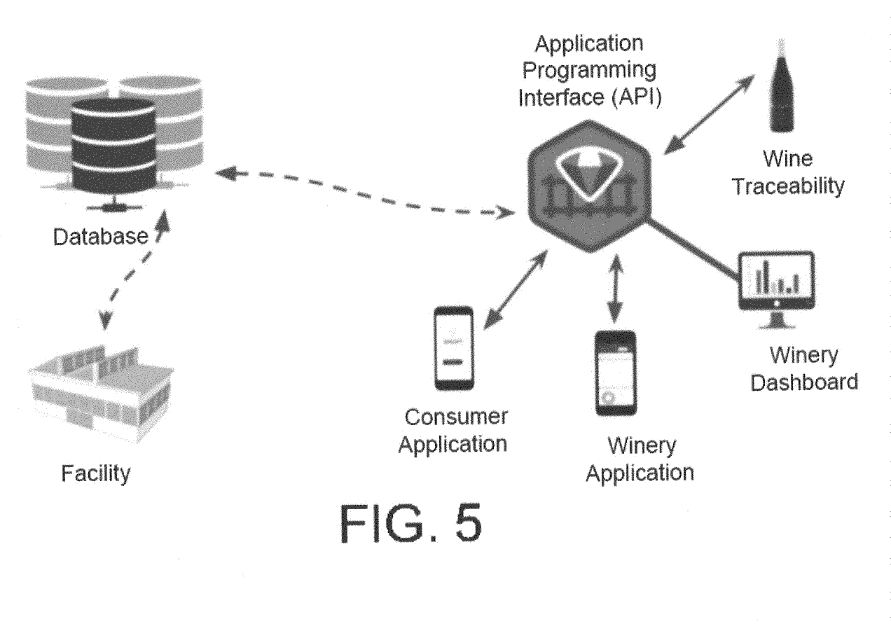

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by any appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

As will be further described below with respect to the preferred embodiment, the present invention is a method of tracking a container closure used to seal liquid in a container. Generally, the method comprises the following steps: (a) applying a trackable indicia to a container closure, wherein the trackable indicia is unique to the container closure; (b) recording an associated data set comprising a plurality of parameters related to the liquid in the container; (c) correlating the associated data set with the trackable indicia; (d) applying the container closure to the container to seal the liquid within the container; (e) maintaining a database of the trackable indicia corresponding to the associated data set; and (f) scanning the trackable indicia to retrieve the associated data set from the database.

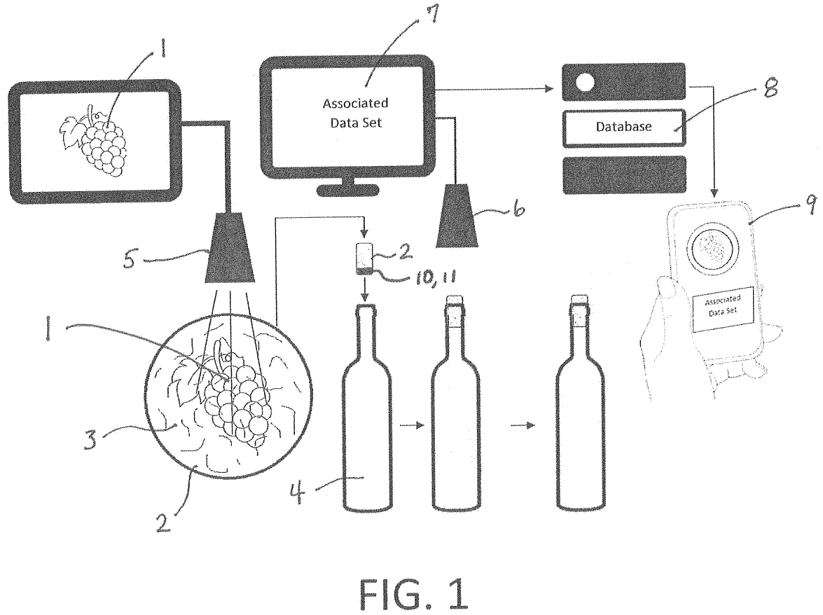

A schematic diagram of an environment in which the invention can be practiced is shown in a preferred embodiment in FIG. 1, which is directed specifically to the use of corks as container closures for sealing wine bottles. In this embodiment, an image 1 is applied to a cork 2 by a laser etching device 5 or similar means to produce a trackable indicia 3 on the cork 2. The indicia 3 is preferably placed on the cork 2 by the cork manufacturer, so that large batches of corks 2 can be provided to the winery for bottling. However, the indicia 3 may also be applied at any time prior to insertion of the cork 2 into the bottle 4. If the indicia 3 is placed on top of the cork 2, the indicia 3 can be readable until and unless it is obscured by other closure materials used to cover the cork 2. For example, wine bottles often contain a plastic or metal wrapping that covers the cork 2. Alternatively, if the indicia 3 is placed on the side of the cork 2, the indicia 3 can be readable immediately prior to its insertion into the bottle 4 with which it will be associated. As further explained below, it is also possible for the indicia 3 to be readable after the cork 2 has been inserted into the bottle 4 through an exposed and transparent area of the bottle 4 itself.

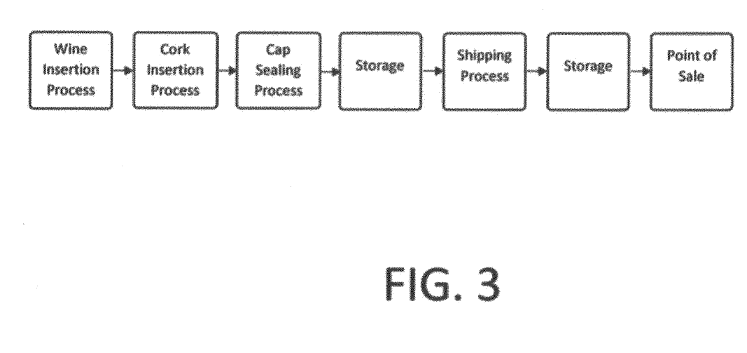

Depending on where the indicia 3 is placed on the cork 2, the trackable indicia 3 can be detected and read by a camera 6 or other scanning or reading device either before or after the cork 2 is inserted into the bottle 4. The indicia 3 is linked to an associated data set 7 and becomes part of a database 8 whose data can be updated during the lifecycle of the bottle 4, such as by mobile scanning devices 9. Typical events in the lifecycle of a bottle 4 may be those events depicted in FIG. 3, although it should be understood that a wide range of variations in such events may be applicable to any particular bottle, without departing the applicability of the present invention.

It should be understood that any reference to “liquid” could be any consumable liquid, but particularly alcoholic beverages such as wine, champagne, beer, distilled spirits, and many other variants. Therefore, any reference herein to wine, corks, and related aspects of distribution, handling, storage, and sale are made solely for the purpose of describing and illustrating the present invention for that specific product, and it should be understood that the invention can be applied with equal effectiveness to many other alternative liquids which are sealed within their respective containers by a closure device. Moreover, there are numerous other consumable and non-consumable liquid products for which a consumer may wish to ascertain similar information stored in an associated data set 7.

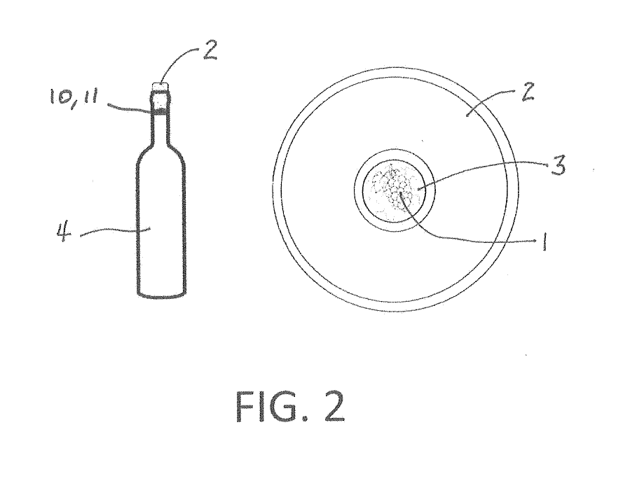

With respect to the trackable indicia, in one embodiment, the trackable indicia 3 comprises a scannable image 1 on the cork 2, such as a bar code, quick response (QR) code, sequence of alphanumeric characters, or other graphic image as shown in FIG. 2. In another embodiment, the trackable indicia may comprise a radio frequency identification (RFID) tag attached to the cork or embedded within the cork. In still another embodiment, the trackable indicia may comprise a scannable pattern unique to the material used to construct the cork 2. For example, in the case of natural corks, the unique pattern of cork material on the cork 2 itself, including any natural imperfections, may be employed as a type of “fingerprint” of that particular cork. Thus, the “fingerprint” of the specific cork 2 can be made to correspond to a unique identifying code which is correlated to the associated data set 7.

With respect to the trackable indicia 3, another embodiment of the trackable indicia 3 may comprise a scannable image on the cork 2 that is encrypted with a watermark which is invisible by human observation, and is only observable to a scanner or imaging device 6 with an approved encryption key. In this indicia 3, the observable image can be any image such as a wine brand logo or manufacturer name. The hidden image may include imperfections in the observable image, such as intentional calculated unique imperfections in the observable image printing process, or natural imperfections in the cork 2 itself that alter the observable image in some unique way. The composite image 1, both the hidden and observable image, can be read by an imaging device 6, such as a smart phone or other image scanner, and an approved encryption key is used to remove the observable image from the composite image in order to read the hidden image. The hidden image provides the unique access code for the cork, wine, and all other data stored in the associated data set 7 for the wine and its path through the value chain.

In the specific case of wine provided in bottles, and as indicated earlier herein, the trackable indicia 3 may be placed anywhere on the cork 2 that enables the indicia 3 to be perceived by the scanning device 6. For example, the indicia 3 may be placed on the side of the cork 2, such that it remains hidden until the cork 2 is removed from the bottle 4. Upon removal of the cork 2, the indicia 3 can then be scanned. Alternatively, if the cork 2 is used to seal a glass wine bottle 4 that has sufficient transparency, the indicia 3 on the cork 2 may be perceived while the cork 2 is still in the bottle 4 through an exposed area on the glass bottle 4.

Regardless of the type of trackable indicia 3 employed with the present invention, all or part of the information in the associated data set 7 can be unlocked based on the authority or credentials of the specific user of the imaging or scanning device, or depending on which encryption key is held by the user.

In a preferred embodiment, the container closure may comprise a natural cork, a synthetic cork, or a screw-type cap. However, it will be understood that any form of closure used to contain the liquid in the bottle may be suitable, and still within the scope of the invention.

With regard to the associated data set 7, the data set may contain any and all information or parameters that may be relevant to the contents of the bottle and which may be desirable to trace. For example, in the case of a specific bottle of wine, a non-exhaustive list of the types of traceable information may be: (1) the cork manufacturing process, including the date of manufacturing, method of manufacturing, inspection quality, etc.; (2) the planting and harvesting details of the grapes, the wine manufacturing process, including barrel information, bottling date, type of wine and its characteristics, and the authenticity of the wine; and (3) case shipment information, including destination, date of packaging, and country of origin. The parameters may also include the conditions at bottling, conditions during maturation (aging), location of bottling, and geographic location of the bottle during movement throughout its life cycle. All such digital data in the associated data set 7 can be stored in an appropriate manner on a suitable computer system or cloud storage for retrieval and/or updating as the circumstances arise.

Once the associated data set 7 for a particular bottle of wine is created and stored, it can be digitally correlated to a specific tracking indicia 3 for the cork 2 in that specific bottle 4. Thus, a database 8 can be created and maintained to allow one-to-one correspondence between the tracking indicia 3 and the associated data set 7. This database 8 is accessed upon a scan of the tracking indicia 3. The database 8 can be stored on a suitable computer system at any location, such as a remote server or cloud storage, which is connected to a global information network, such as the Internet.

The scanning is preferably performed using a mobile device 9 wirelessly connected to the Internet. For example, a consumer or anyone interested in the bottle of wine, should be able to scan the indicia 3 with the camera features or other scanning technology that reside on a smart phone 9. As the smart phone 9 is typically connected to the Internet, via a cellular or wireless communication protocol, data received from the scanned indicia 3 can be sent to the database 8 for retrieval of the associated data set 7 that corresponds to that particular indicia 3. Of course, depending on the authentication credentials of the user, only certain types of data access from the database 8 may be permissible.

The method may further comprise the step of updating the associated data set 7 by scanning the trackable indicia 3 upon the occurrence of predetermined events, and recording information about the predetermined events to the associated data set 7. By way of example, the predetermined events may comprise one or more of the following: transfer of possession of the bottle 4, removal of the cork 2 from the bottle 4, and consumption of the wine. Rare or expensive bottles of wine are often bought and sold several times before they are consumed, and a buyer may find it useful to know details about the persons in possession of the bottle 4 since the first sale, or perhaps the conditions in which the bottle 4 was kept.

It is also within the scope of the present invention to include a sensing device 10 within the cork 2 to detect various conditions related to the bottle of wine. For example, some of the many parameters that might be sensed and tracked are age, internal pressure, temperature, oxygen and carbon dioxide levels, and acid concentrations. Suitable transducers which sense these parameters can record data associated with those values and store them in memory 11 located adjacent to the sensing device 10, and such parameter data can be transmitted wirelessly through an included communication device (including RFID or similar technology) as explained above and incorporated into the associated data set 7.

With the above features of the present invention in mind, the commercial implementation of the tracking indicia 3 and the database 8 can include a smartphone application available to consumers, as well as a business-focused software interface for wineries that significant enhance the effectiveness and utility of the process. Each of these additional components would be in communication with the database 8 and are described further below.

With respect to the smartphone application installed on a mobile device 9, a consumer will typically shop at a wine retailer, and he will view the wines available for purchase on the retailer's shelves. The consumer can use the app, in conjunction with the camera and scanning features of the device 9, to scan wine bottle labels to receive limited but unique information about the wine to make a purchase decision. Also, if the trackable indicia 3 is exposed to the consumer, as explained above, the consumer would be able to access additional information about that specific bottle. The data received from the database 8 and the associated data set 7 may include the wine brand, consumer ratings, and winery rewards. If the trackable indicia 3 is not exposed to the consumer until after the cork is removed, then after removing the cork 2 and opening the wine bottle, a scan of the trackable indicia 3 on the cork 2 can now allow the consumer to view the story of the wine and its unique taste and related qualities. Furthermore, the consumer can collect rewards, input their personal information, rate their wine, enhance their social status in the wine world by integrations with social media platforms, and communicate with the winery.

With respect to the software interface for wineries, sometimes referred to as a “dashboard”, the data generated from grape-to-glass, including consumer information uploaded during the wine lifecycle, provides the winery with a wealth of valuable information on the product and consumer characteristics. This additional data becomes a part of the database 8 and the associated data set 7 and is curated and presented to the winery in the form of trends, demographics, social statistics, growth opportunities, competitive advantages, and any other data useful to the winery. The wineries can then use this information to make more strategic distribution and branding decisions as well as create direct-to-consumer advertising and incentives.

As will be appreciated, the above method and its many features will have a significant and positive effect on the wine value chain. For cork manufacturers, the present invention creates enhanced cork sales opportunities to their direct consumers, which are the wineries themselves. For retail wine consumers, the added values would be: (1) social media connections to friends based on mutual interests in wines, (2) wine preference prediction and ratings, (3) wine purchasing rewards and incentives, (4) unique wine history and traceability data, (5) wine and cork education opportunities, and (5) more entertaining point-of-sale experiences. For wineries, the added value would be: (1) deeper consumer profile information (“thick data”), (2) large scale consumer trends (“big data”), (3) point-of-sale communication directly to the consumer, and (4) increased customer and brand loyalty.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. A method of tracking a container closure used to seal liquid in a container, comprising:
(a) applying a trackable indicia to a container closure, wherein the trackable indicia is unique to the container closure;
(b) recording an associated data set comprising a plurality of parameters related to the liquid in the container;
(c) correlating the associated data set with the trackable indicia;
(d) applying the container closure to the container to seal the liquid within the container;
(e) maintaining a database of the trackable indicia corresponding to the associated data set; and
(f) scanning the trackable indicia to retrieve the associated data set from the database.

2. The method of claim 1, further comprising updating the associated data set by scanning the trackable indicia upon the occurrence of predetermined events, and recording information about the predetermined events to the associated data set.

3. The method of claim 2, wherein the predetermined events may comprise one or more of the following: transfer of possession of the container, removal of the container closure from the container, and consumption of the liquid.

4. The method of claim 1, wherein the plurality of parameters may comprise one or more of the following: liquid production data, qualities of the liquid, conditions present during filling of the container, conditions during aging of the liquid, and geographic data during movement of the container over time.

5. The method of claim 1, wherein the trackable indicia comprises a scannable image on the container closure.

6. The method of claim 5, wherein the scannable image is a bar code.

7. The method of claim 5, wherein the scannable image is a quick response (QR) code.

8. The method of claim 5, wherein the scannable image is a unique series of alphanumeric characters.

9. The method of claim 1, wherein the trackable indicia comprises a radio frequency identification (RFID) tag attached to the container closure.

10. The method of claim 1, wherein the trackable indicia comprises a scannable pattern unique to material used to construct the container closure.

11. The method of claim 1, wherein the container closure may comprise a natural cork.

12. The method of claim 1, wherein the container closure may comprise a synthetic cork.

13. The method of claim 1, wherein the liquid may comprise an alcoholic beverage.

14. The method of claim 1, wherein the step of scanning is performed using a mobile device wirelessly connected to a global information network.

15. The method of claim 1, wherein the container closure includes a sensing device within the container closure adapted to detect one or more parameters related to the liquid in the container, and further includes a memory adapted to store parameter data.

16. The method of claim 15, wherein the parameters related to the liquid are one or more of the following liquid conditions: age, internal pressure, temperature, oxygen and carbon dioxide levels, and acid concentration.

17. The method of claim 16, wherein the parameter data stored in the memory is transmitted wirelessly to a mobile device and added to the associated data set.
